(19) United States
(12) Patent Application Publication
(10) Pub. No.: US 2003/0012012 A1
(43) Pub. Date: Jan. 16, 2003

(54) Protective cover with light for handheld electronic game

(76) Inventor: Shum Chi Hong, Hong Kong (HK)

Correspondence Address: Hoffman, Wasson & Gitler, P.C., Suite 522, 2361 Jefferson Davis Highway, Arlington, VA, 22202, US

(21) Appl. No.: 09/903,772

(22) Filed: Jul. 13, 2001

(51) Int. Cl. F21V 33/00

(52) U.S. Cl. 362/85; 362/109; 362/234; 362/253; 439/638

(57) ABSTRACT

A lighting device and protective cover for a screen for a hand held portable compact computer video screen system. The device contains a cover which substantially conforms to the size and shape of the screen of the electronic device and in addition it includes an unique lighting system which is part of the cover.

### BACKGROUND OF THE INVENTION

A device which functions as both a lighting apparatus and a protective cover for a screen for a handheld electronic device. The device is particularly suitable for a portable compact computer video screen system having a video viewing screen of a generally flat liquid crystal nature, such as is known as GAMEBOY ADVANCE™ (a trademark of Nintendo of America). The Nintendo device provides a compact, self-contained, battery operated, portable, handheld video game system with an LCD view screen and controls.

The video display screen employed, included a flat LCD type screen and is difficult to observe by the user in partial light.

It is desirable to provide a device which acts as both a lighting apparatus and when not in use, a protective cover for the screen of the portable computer device.

### SUMMARY OF THE INVENTION

The present invention relates to a combined light apparatus and protective cover for a compact computer vide screen. More particularly, the invention concerns a portable, combined light and screen cover apparatus for use with a portable, battery operated, hand held computer video screen systems employing an LCD screen to enhance the user's view of the screen and protect the screen when the device is not in use.

The device generally includes a main molded body section and a second separate body section also made from a molded piece of plastic, or the like. The second body section contains a connector for attachment to the utility port of a hand held computer video screen system. It also contains an outlet port of its own to facilitate linkage with other hand held computer video screen systems, cables or external attachment devices. Further, the second body section contains lighting controls, namely, an on-off switch and a dimmer switch for control of the lighting apparatus.

The lighting apparatus is contained in an end of the main molded body section and is connected to the lighting controls contained in the second body section via a wire which runs along the interior of the main molded body section. The lighting apparatus is non-glare and the main body section protects the screen of the video display device from dings and scratches when it is in the closed position.

In addition, the light apparatus and protective cover has the following features: the device flips up and lights the screen for night play; it protects the video screen from scratches; it has a built-in dimmer switch; no batters are required; and the device has a pass-through port for link cables.

Further, the device can be attached to a video system device (such as GAMEBOY ADVANCE™) via a pair of spaced apart detents, in addition to the port link for secure attachment of the second molded body section thereto.

### BRIEF DESCRIPTION OF THE DRAWINGS

FIG. 1 is a perspective view from above showing the protective cover with light for hand held electronic game embodying the invention;

FIG. 2 is a top view of the protective cover with light for hand held electronic game embodying the invention;

FIG. 3 is a rear elevational plan view of the section body section of the protective cover with light for hand held electronic game embodying the invention;

FIG. 4 and FIG. 5 are side plan elevational views of the protective cover with light for hand held electronic game embodying the invention;

FIG. 6 is a front elevational plan view of the section body section of the protective cover with light for hand held electronic game; and

FIG. 7 is a bottom view from an underside of the shield.

### DESCRIPTION OF THE PREFERRED EMBODIMENTS

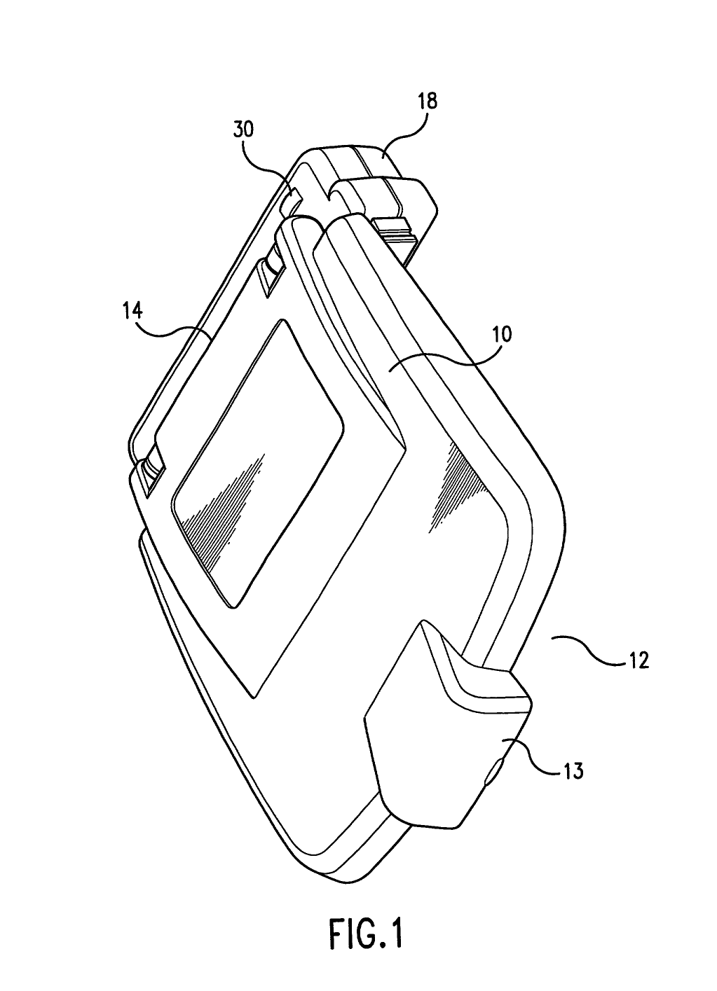

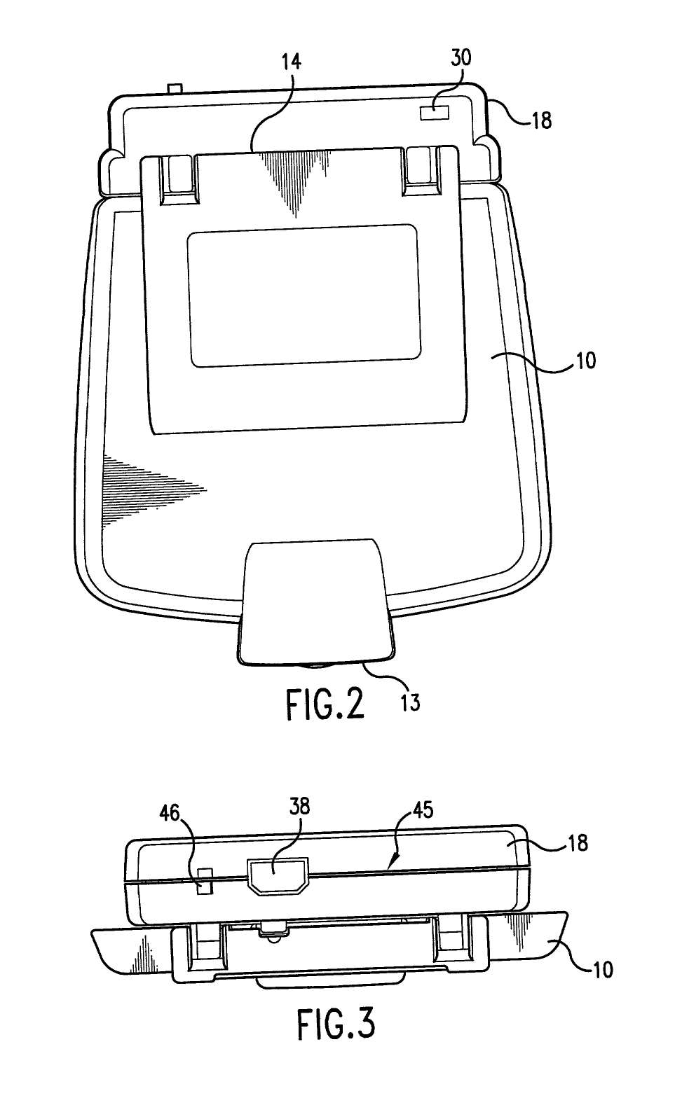

FIG. 1 illustrates the protective cover with light apparatus for a handheld electronic game embodying the invention from a top perspective view. The protective cover with light is extremely suitable for the Nintendo GAMEBOY ADVANCE™ compact computer apparatus (not shown) having a video screen. The portable compact light apparatus and protective cover device 12 has a main body 10 which houses the light apparatus and which acts as a cover when the light is not in use. The cover is adapted to conform to the size and shape of the compact computer video screen. The device has a first end 13 and a second end 14 with a light apparatus 62 mounted on the underside of an extended portion on the first end 13 (see FIG. 7). The light 62 is connected via at least one wire 64 mounted on the underside of the cover and if desired, encased in a protective plastic material 66. The plastic can be any suitable protective material and, if desired, a transparent material. There is a second main body section 18 which is pivotally connected to the main body section 10. The second body section 18 has a link port 20 for accessing and attaching to a power supply of the compact computer video screen system which acts to power the light apparatus 62. On the second main body section 18, there is provided a dimmer switch or mechanism 30 which allows for the control of the intensity of the light apparatus 62. Any suitable switching mechanism can be utilized for this purpose.

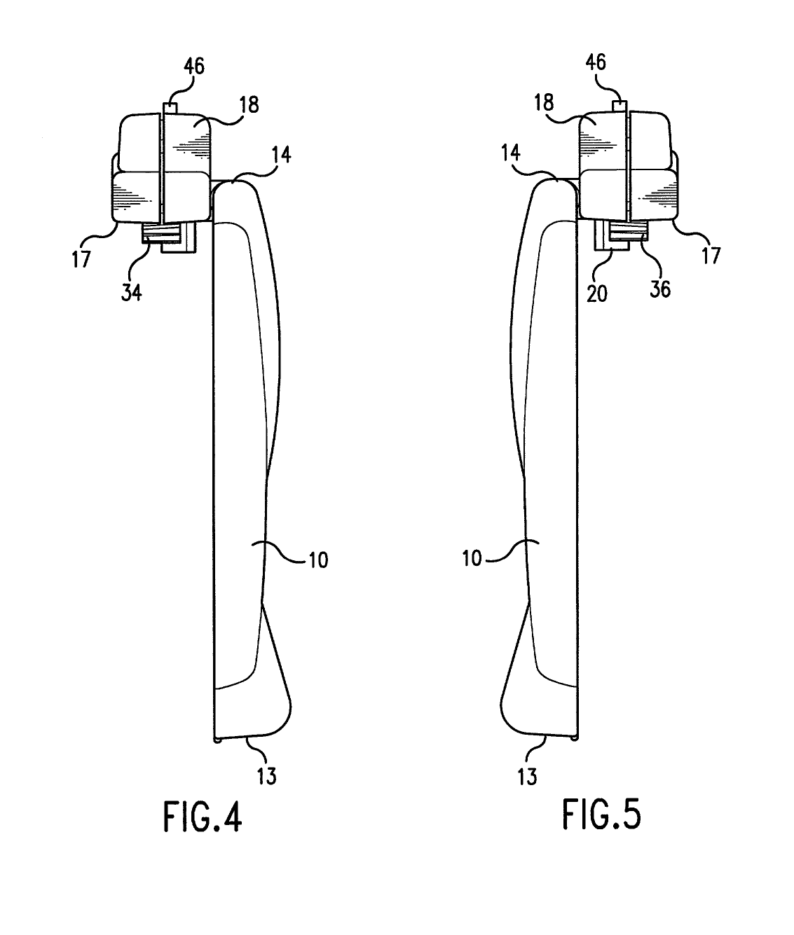

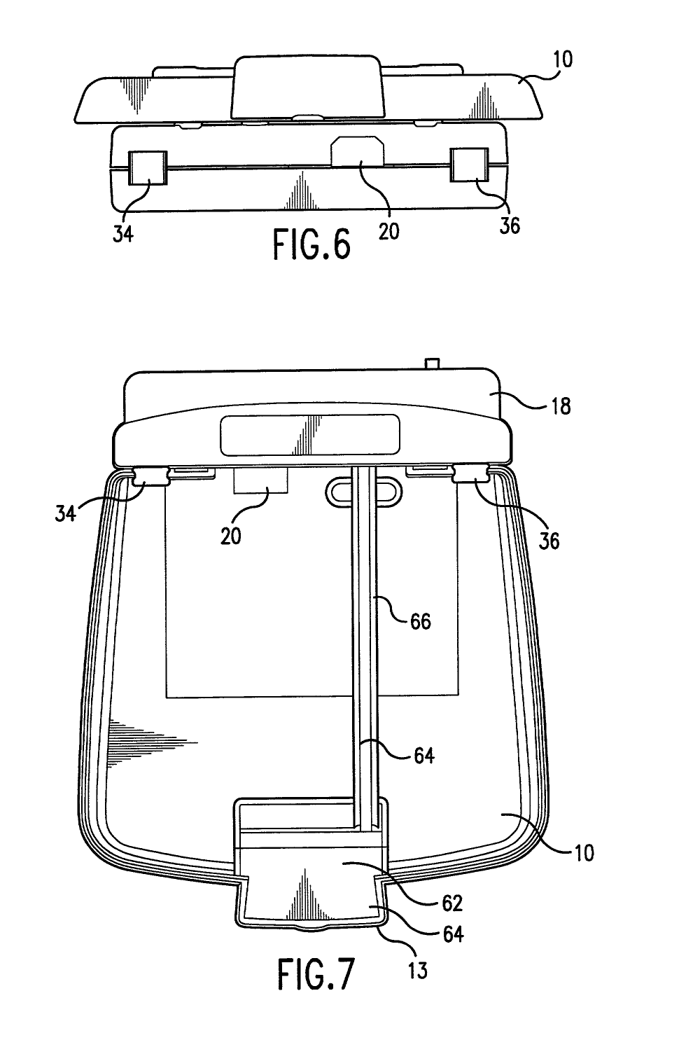

In FIGS. 4 and 5, one can see means 34 and 36 for attaching the second body section 18 to a compact computer video screen system (not shown). This means may include at least one extension point, or detent, shown as numerals 34 or 36 located on the face 17 of second body part 18 for engagement with the compact computer video screen system. These extensions can be one, two, three, four, or more, detents which are spaced apart on alternate ends of the second main body part 18 for secure engagement with the compact computer video screen system. Also provided, if desired, as seen in FIG. 3, is an external port 38 for attaching additional devices, cables and linking compact computer video screen systems together. On the rear face 45 of the second main body portion 18, there is also provided an on-off switching means 46. This external port easily facilitates the attachment of any type of additional device or cable.

The lighting apparatus 62 can also have a glare cover or screen 64 to enhance the screen image of the compact computer video screen system.

The invention is described for the purposes of illustration in connection with certain preferred embodiments; however, it is recognized that various changes, modifications, additions and improvements may be made to the illustrated embodiments by those persons skilled in the art without departing from the spirit and scope of the invention.

What is claimed is:

1. A portable, compact, light and protective cover device, for use with a compact computer video screen system, comprising:
a) a main body which defines a cover, the cover adapted to conform generally to the size and shape of the compact computer video screen, having a first end and a second end, and a light apparatus mounted on an inside of the first end of the cover and a wire running from the light apparatus to the second end; and
b) a second body section pivotally connected to the main body and the wire, having a link port for accessing and attaching to a power supply of the compact computer video screen system and powering the light apparatus.

2. The portable, compact, light and protective cover device, for use with a compact computer video screen system according to claim 1, further comprising a control switch on the second body section to operate the light.

3. The portable, compact, light and protective cover device, for use with a compact computer video screen system according to claim 1, further comprising a dimmer switch for controlling the lighting apparatus mounted on the second body section.

4. The portable, compact, light and protective cover device, for use with a compact computer video screen system according to claim 1, further comprising means for attaching the second body section of the portable, compact, light and protective cover device to the compact computer video screen system.

5. The portable, compact, light and protective cover device, for use with a compact computer video screen system according to claim 4, wherein the means for attaching the second body section are spaced apart detents.

6. The portable, compact, light and protective cover device, for use with a compact computer video screen system according to claim 1, further comprising an exterior port on the second body section for attachment of cables and external devices.

7. The portable, compact, light and protective cover device, for use with a compact computer video screen system according to claim 1, wherein the light apparatus has a glare cover to enhance a screen image of the compact computer video screen system.

8. A portable, compact, light and protective cover device, for use with a compact computer video screen system, comprising:
a) a main body which defines a cover, the cover adapted to conform generally to the size and shape of the compact computer video screen, having a first end and a second end, and a light apparatus mounted on an inside of the first end of the cover and a wire running from the light apparatus to the second end;
b) a second body section pivotally connected to the main body and the wire, having a link port for accessing and attaching to a power supply of the compact computer video screen system and powering the light apparatus;
c) a control switch on the second body section to operate the light;
d) a dimmer switch for controlling the lighting apparatus mounted on the second body section;
e) means for attaching the second body section of the portable, compact, light and protective cover device to the compact computer video screen system; and
f) an exterior port on the second body section for attachment of cables and external devices.

9. The portable, compact, light and protective cover device, for use with a compact computer video screen system according to claim 8, wherein the light apparatus has a glare cover to enhance a screen image of the compact computer video screen system.
